(19) United States
(12) Patent Application Publication
(10) Pub. No.: US 2026/0076472 A1
(43) Pub. Date: Mar. 19, 2026

(54) SYSTEM AND METHOD FOR HOLSTERING A HAND-HELD GRIPPER

(71) Applicant: Toyota Research Institute, Inc., Los Altos, CA (US)

(72) Inventors: Richard Denitto, Watertown, MA (US); Reko Ong, San Leandro, CA (US)

(73) Assignees: Toyota Research Institute, Inc., Los Altos, CA (US); Toyota Jidosha Kabushiki Kaisha, Aichi-Ken (JP)

(21) Appl. No.: 19/023,763

(22) Filed: Jan. 16, 2025

Related U.S. Application Data
(60) Provisional application No. 63/694,483, filed on Sep. 13, 2024.

(51) Int. Cl. A45F 5/00; A45F 3/14; A45F 5/02

(52) U.S. Cl. CPC A45F 5/1575; A45F 3/14; A45F 5/021; A45F 2003/144

(57) ABSTRACT

An adjustable holster system including a belt to wrap around a waist of a user, a collar allowing holstering of a gripper within open space, the collar including at least three sides around the open space, a height adjuster connected to the collar to adjust a vertical position of the collar, and a hook to connect the height adjuster to the belt, wherein, when the user holsters the gripper within the open space, the sides of the collar hold retractable fingers of the gripper in place.

### CROSS-REFERENCE TO RELATED APPLICATION

This application claims priority to, and all benefits of, U.S. Provisional Application No. 63/694,483, filed Sep. 13, 2024, for “Universal Manipulation Interface,” which is hereby incorporated by reference in its entirety including the drawings.

### TECHNICAL FIELD

The present specification relates to holstering a hand-held gripper and more particularly to a system and method for holstering a hand-held gripper.

### BACKGROUND

Users performing tasks with hand-held grippers may require a convenient method to store and access the gripper during intermittent use. Traditional methods may involve setting the gripper down on a surface or holding it continuously, which may be inconvenient and reduce efficiency. Additionally, repeated storage and access can cause strain, especially if the user must travel or apply excess force. Existing holster systems may not provide adjustable positioning to accommodate different heights or may not securely hold a hand-held gripper in place during movement. Therefore, there is a need for an adjustable holster system that allows secure holstering of a hand-held gripper, easy access during tasks, adjustable positioning to accommodate different users, and minimal strain during use.

### SUMMARY

In an embodiment, an adjustable holster system may include a belt to wrap around a waist of a user, a collar allowing holstering of a gripper within open space, the collar including at least three sides around the open space, a height adjuster connected to the collar to adjust a vertical position of the collar, and a hook to connect the height adjuster to the belt, wherein, when the user holsters the gripper within the open space, the sides of the collar hold retractable fingers of the gripper in place.

In an embodiment, an adjustable holster system may include a belt to wrap around a waist of a user, including one or more attachment loops for connecting accessories, a collar allowing holstering of a gripper within open space, the collar including at least three sides around the open space, a height adjuster connected to the collar to adjust a vertical position of the collar, and a hook to connect the height adjuster to the attachment loops, wherein the gripper includes a trigger and retractable fingers to be retracted by the trigger, the retractable fingers fully opening when the trigger is released, and wherein, when the user holsters the gripper within the open space, the sides of the collar hold retractable fingers of the gripper in place.

In another embodiment, a method may include activating a trigger of a gripper to fully close a set of retractable fingers, removing the gripper from a collar shaped to allow holstering of the gripper and to allow securing of the retractable fingers against the collar, holding the gripper to perform an action by a user, activating the trigger of the gripper to fully close the set of retractable fingers, holstering the gripper into the collar, and deactivating the trigger of the gripper to open the set of retractable fingers until contact is made with the collar, securing the retractable fingers against the collar.

### BRIEF DESCRIPTION OF THE DRAWINGS

The embodiments set forth in the drawings are illustrative and exemplary in nature and are not intended to limit the subject matter defined by the claims. The following detailed description of the illustrative embodiments can be understood when read in conjunction with the following drawings, where like structure is indicated with like reference numerals and in which:

FIG. 1A schematically depicts a perspective view of an example holster system, according to one or more embodiments described and illustrated herein;

FIG. 1B schematically depicts a perspective view of the holster system of FIG. 1A, being used to holster an example hand-held gripper, according to one or more embodiments shown and described herein.

FIG. 2 schematically depicts a perspective view of the holster system of FIG. 1A, according to one or more embodiments shown and described herein;

FIG. 3 schematically depicts a perspective view of the collar of FIG. 1A, holding a hand-held gripper, according to one or more embodiments shown and described herein;

FIG. 4 schematically depicts a perspective view of the hook and height adjuster adjacent to the collar of FIG. 1A, according to one or more embodiments shown and described herein; and

FIG. 5 schematically depicts a cross-sectional side view of the hook and height adjuster of FIG. 1A, according to one or more embodiments shown and described herein.

### DETAILED DESCRIPTION

In embodiments, a hand-held griper including a holster, which may be part of a Universal Manipulation Interface (UMI), provides a practical and accessible framework to unlock new robot manipulation skills, allowing a user to demonstrate any actions in any environment while maintaining high transferability from human demonstration to robot policy. A hand-held data collection and policy learning framework may be employed to allow direct transfer from in-the-wild human demonstrations to deployable robot policies.

The embodiments disclosed herein include a system and method for operating a holster of a hand-held gripper, such as a holster of a hand-held gripper that is part of a UMI. As disclosed herein, when a user performs tasks with a hand-held gripper and records data, it may be desirable to stop between the performance of each task. However, this may be inconvenient if the user must let go of and store the hand-held gripper between tasks. A holster is provided for quick storage and quick access to perform various tasks between tasks, allowing for more efficient data collection.

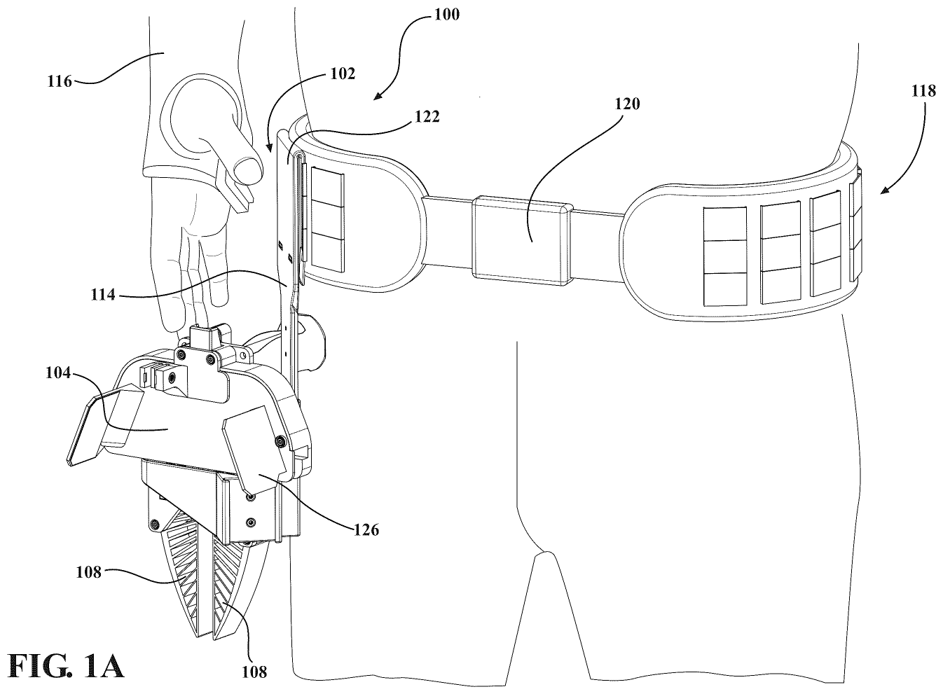

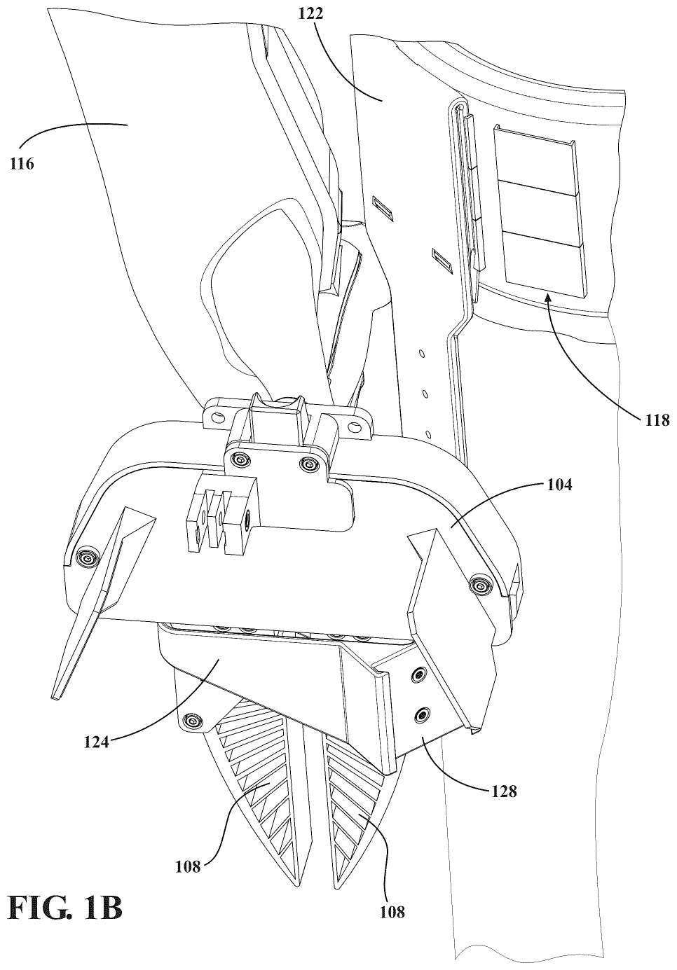

Turning now to the figures, FIG. 1A depicts an example adjustable holster system 100 being worn by a user. The adjustable holster system 100 includes a holster 102 and a belt 118. The holster 102 includes a hook 122, a height adjuster 114, a collar 124, and a height adjustment track 126. The belt 118 includes a buckle 120. The adjustable holster system 100 is designed to hold a gripper 104. The gripper 104 includes at least two retractable fingers 108. The gripper 104 may connect to a wrist brace 116.

In some embodiments, the gripper 104 is positionable between an open position, a closed position, and a partially closed position between the open position and the closed position. The gripper 104 has a holstered position where the retractable fingers 108 are completely inserted into the collar 124. The collar 124 may have at least three sides to create an open space to holster the gripper 104. The gripper 104 has a removed position where the entire gripper 104 is outside of the collar 124. FIG. 1A illustrates the gripper 104 in the holstered position. The buckle 120 is postionable between a closed position where the belt 118 is enclosed and an open position where the belt 118 is not enclosed. The buckle 120 is illustrated in FIG. 1A as being positioned in the closed position.

In the embodiment illustrated in FIG. 1A, the hook 122 connects the holster 102 to the belt 118. The height adjuster 114 may adjust the vertical position of the collar 124 in a vertical direction from the hook 122 by moving or extending the height adjustment track 126 along the height adjuster 114. For instance, in some embodiments, the height adjuster 114 may allow for upward and downward motion of the height adjustment track 126 in a vertical direction with respect to the belt 118. The collar may also separate from the hook 122. Also, the collar 124 is shaped to allow holstering of objects such as the gripper 104. When the gripper 104 is holstered in the collar 124, the retractable fingers 108 are inhibited from fully opening, causing the retractable fingers 108 to remain at least partially closed. The gripper 104 includes the camera 106 which is mounted to capture data during manipulation tasks. The retractable fingers 108 of the gripper 104 interact with objects in the environment by squeezing and moving them, performing manipulation tasks. The gripper 104 may be connected to the wrist brace 116 for additional support during use. The belt 118 wraps around the waist of the user and includes the buckle 120, which encloses belt 118 allowing it to be secured in place.

FIG. 1B depicts the gripper 104 as partially removed and in the closed position. The gripper 104 includes a handle 110 and a trigger 112. Activating the trigger 112 closes or retracts the retractable fingers 108, placing the gripper 104 in the closed position. Releasing the trigger 112 opens the retractable fingers 108, placing the gripper 104 in the open position. The gripper 104 may pass into or out of the collar 124 when the trigger 112 is activated and the gripper 104 is placed in the closed position.

In operation, the user may activate the trigger 112 to close the retractable fingers 108, remove the gripper 104 from the collar 124, and perform a manipulation task. After completing the manipulation task, the user may activate the trigger 112 to fully close the retractable fingers 108 and holster the gripper 104 into the collar 124. Releasing the trigger 112 allows the retractable fingers 108 to open until contact is made with the collar 124, securing the gripper 104 within the collar 124 by the force separating the retractable fingers 108.

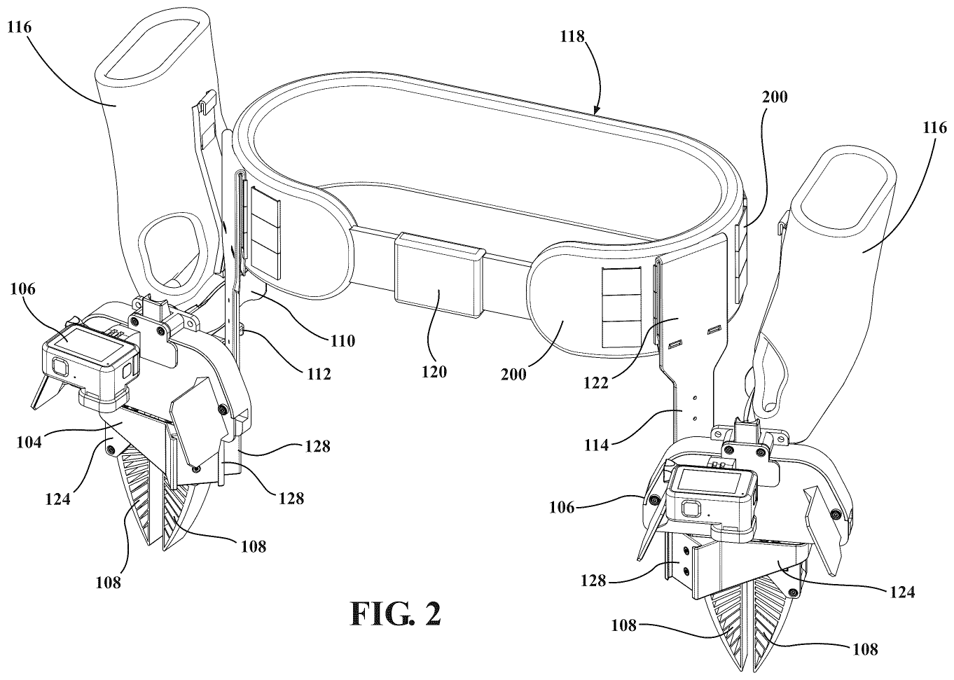

FIG. 2 depicts an embodiment of an adjustable holster system 100, illustrating two holsters 102 attached to the belt 118. The belt 118 includes multiple attachment loops 200. In this embodiment, some attachment loops 200 are occupied by hooks 122, which secure the holsters 102 to the belt 118. In some embodiments, one holster 102 may include multiple hooks 122. Therefore one holster 102 may occupy multiple attachment loops 200. The holsters 102 shown in FIG. 2 each occupy two attachment loops 200.

As illustrated in FIG. 2, each holster 102 contains a gripper 104, which includes a camera 106. Each camera 106 records tasks done by a user, facilitating data capture for the UMI. In the illustrated embodiment, each gripper 104 also includes a handle 110 and a trigger 112. Although the trigger 112 is not activated, the gripper 104 is not in an open position. This is due to the collar 124, which is sufficiently wide to fit the gripper 104 when in the closed position, but not as wide as the retractable fingers 108 when the gripper 104 is in the open position. Each gripper 104 is further configured with a wrist brace 116 for additional support, which includes a wrist brace connector 202, a wrist brace wrist opening 204, and a wrist brace thumb opening 206.

In some embodiments, the wrist brace connector 202 is adjacent to the handle 110 and accepts the wrist brace 116. The wrist brace connector 202 is designed for attachment and detachment from the handle 110. Additionally, the wrist opening 204 and the thumb opening 206 are shaped to allow a user's wrist and thumb respectively to enter and retract from the wrist brace 116, supporting the gripper 104 and the wrist brace 116 while holstered. When a user has the wrist brace 116 connected to the wrist brace connector 202, their wrist in the wrist brace wrist opening 204, and their thumb in the wrist brace thumb opening 206, the user has more control of the gripper 104.

Referring still to FIG. 2, a plurality of height adjustment tracks 126 are illustrated on each holster 102. In this embodiment, several height adjustment tracks 126 are shown, with some attached to the height adjuster 114 and some empty. The height adjustment tracks 126 that are attached to the height adjuster 114 are hidden or partially hidden within the illustration. Other height adjustment tracks 126, which are not in use, remain visible and would be able to accept the height adjuster 114 if repositioning or adjustments to the holster 102 are required.

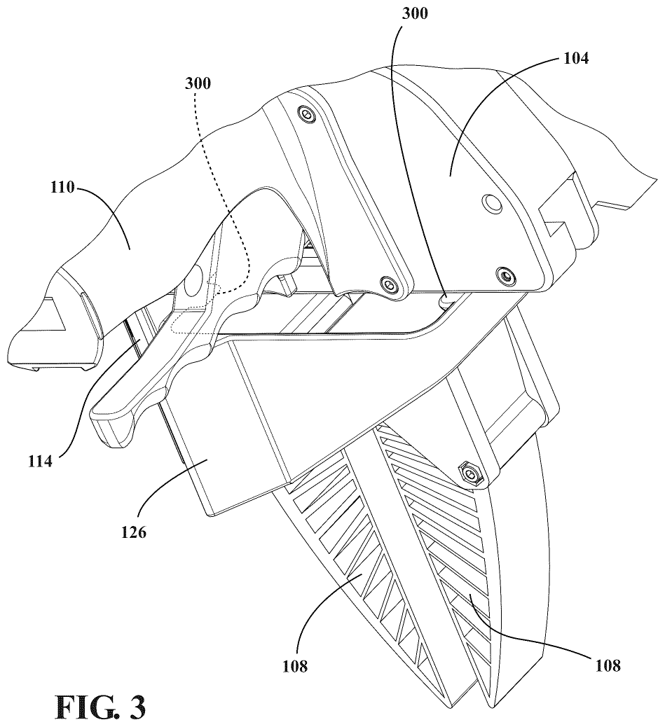

FIG. 3 depicts the collar 124, which includes a collar retention notch 300 and a collar opening 308. The collar 124, in this embodiment, is configured to house the gripper 104 with its retractable fingers 108 secured inside. The collar 124 illustrated in FIG. 3 has two collar retention notches 300. The gripper 104 includes a gripper main body 306 and retractable fingers 108. Retractable fingers 108 further include a finger proximal end 302 and a finger distal end 304. Open space may exist between the gripper main body 306 and the retractable fingers 108, particularly between the gripper main body 306 and the finger proximal ends 302.

In some embodiments, the collar 124 may have an enclosed perimeter. In other embodiments, the collar 124 may have a perimeter which is open. For instance, the collar 124 may have a perimeter with only three sides. Either configuration presents a width of the collar opening 308. The collar retention notch 300 protrudes into the collar opening 308 determining the width of the collar opening 308. Therefore, the collar retention notch 300 may control the space available for inserting or removing the gripper 104. As illustrated in FIG. 3, the collar 124 restricts the gripper main body 306 from fitting through the collar opening 308.

In some embodiments, when the trigger 112 is deactivated, the retractable fingers 108 cannot fit through the collar opening 308. However, upon full activation of the trigger 112, the retractable fingers 108 compress, allowing the retractable fingers 108 to pass through the collar opening 308. Once the gripper 104 is holstered by activating the trigger 112, inserting the gripper 104 until the gripper main body 306 touches the collar 124, and deactivating the trigger 112, the retractable fingers 108 will expand. The retractable fingers 108 then make contact with the collar retention notch 300, while the collar retention notch 300 also partially occupies the open space between the gripper main body 306 and finger proximal ends 302.

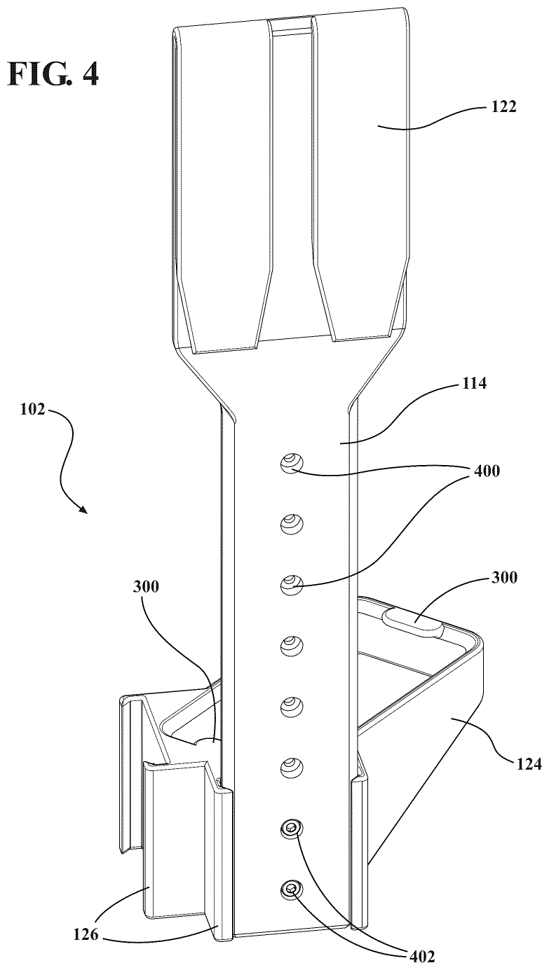

FIG. 4 depicts the hook 122 and the height adjuster 114 positioned in front of the collar 124. The holster 102 in this embodiment includes two hooks 122. The height adjuster 114 includes a plurality of adjustment holes 400, providing options for adjusting the vertical position of the collar 124 and any holstered gripper 104. The holster 102 also includes height adjustment receptacles 404. The embodiment shown in FIG. 4 includes two height adjustment receptacles 404, vertically in line, in each height adjustment track 126. The adjustable holster system 100 includes height adjustment connectors 402, which may be screws, pins, or other fasteners, insertable through the adjustment holes 400 and into the height adjustment receptacles 404.

In some embodiments, the adjustment holes 400 are arranged linearly along the height adjuster 114 and are equidistantly spaced apart from one another. The adjustment holes 400 may be spaced such that two height adjustment connectors 402 can be placed through the holes 400 and into the height adjustment receptacles 404 at the same time. The adjustment holes 400 may each have a circular cross-section and extend completely through the height adjuster 114. Further, the adjustment holes 400 may include two different widths. One width may be a narrower portion matching the diameter of the height adjustment receptacles 404 and the other width may be wider portion sized to accommodate the head of the height adjustment connectors 402.

The height adjustment connectors 402 and the height adjustment receptacles 404 create a connection between the height adjuster 114 and the height adjustment track 126. FIG. 4 illustrates the height adjustment receptacle 404 as a threaded hole and the height adjustment connector 402 as a screw, enabling adjustable attachment of the height adjuster 114 to the adjustment track 126. The size of the height adjuster 114 and number of height adjustment receptacles 404 allows the height adjuster 114 the ability to slide within the height adjustment track 126 while still connecting to the adjustment track 126.

In other embodiments, upper and lower height limits may be established to restrict the movement of the height adjuster 114. These height limits may be a result of the size of the height adjuster 114 compared to the height adjustment track 126, preventing the height adjuster 114 from sliding beyond certain points in the height adjustment track 126. Height limits could also arise from the positioning of specific adjustment holes 400.

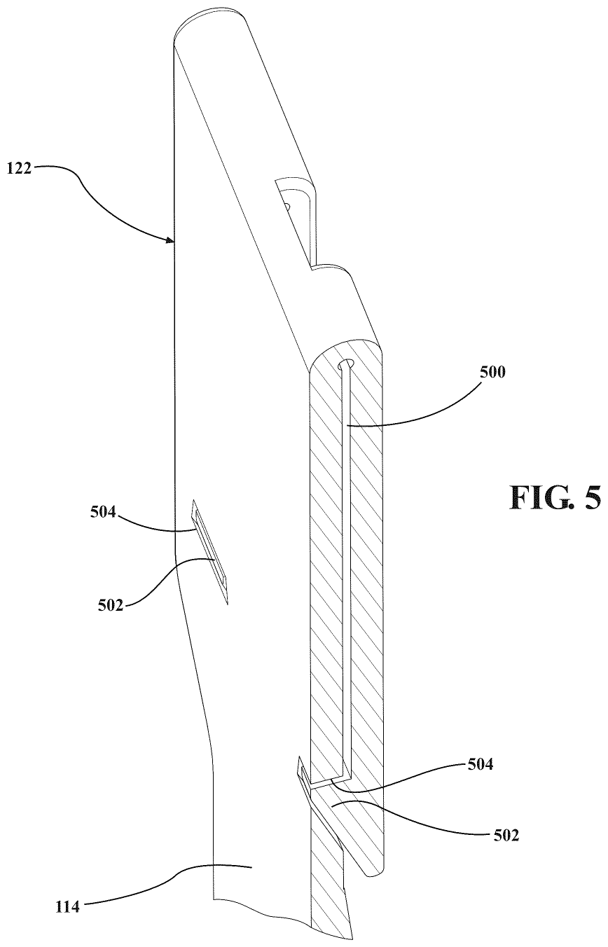

FIG. 5 depicts a schematic diagram including two hooks 122 and a height adjuster 114. The hooks 122 include a belt channel 500, a locking wedge 502, and a locking recess 504. FIG. 5 illustrates a cross section of the holster 102 through a locking recess 504. The belt channel 500 is a vacant space that allows an attachment loop 200 (FIG. 2), or other accessory such as a belt 118 (FIG. 2), to occupy. In rest, the locking wedge 502 is positioned inside of the locking recess 504, enclosing the vacant space of the belt channel 500.

In some embodiments, one side of the locking wedge 502 is shaped on an angle so that a user of the holster 102 may slide the hook 122 over an attachment loop 200 (FIG. 2), or other accessory such as a belt 118 (FIG. 2), bending the hook 122 until the locking wedge 502 exits the locking recess 504 allowing the accessory to pass into the belt channel 500. In this embodiment, one side of the locking wedge 502 is flat so that the attachment loop 200, or other accessory, does not exit the belt channel 500 once it has entered. The accessory may exit when a user manually removes the locking wedge 502 from the locking recess 504 and removes the accessory from the belt channel 500. The locking wedge 502 and the locking recess 504 may be on opposite sides of the holster 102. The locking wedge 502 may be on the same side of the holster 102 as the collar 124. The locking recess 504 may be on the same side of the holster 102 as the collar 124.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An adjustable holster system, comprising:
a belt to wrap around a waist of a user;
a collar allowing holstering of a gripper within open space, the collar including at least three sides around the open space;
a height adjuster connected to the collar to adjust a vertical position of the collar; and
a hook to connect the height adjuster to the belt;
wherein, when the user holsters the gripper within the open space, the sides of the collar hold retractable fingers of the gripper in place.

2. The adjustable holster system of claim 1, wherein the belt includes one or more attachment loops.

3. The adjustable holster system of claim 1, wherein the collar includes one or more height adjustment tracks.

4. The adjustable holster system of claim 3, wherein the height adjustment track is movable upward and downward in a vertical direction with respect to the belt.

5. The adjustable holster system of claim 1, wherein the collar contacts retractable fingers tightly secures the gripper when partially closed.

6. The adjustable holster system of claim 1, wherein the height adjuster includes upper and lower height limits.

7. The adjustable holster system of claim 1, wherein the height adjuster extends in a vertical direction from the hook.

8. The adjustable holster system of claim 1, wherein the hook and the collar are separable.

9. An adjustable holster system, comprising:
a belt to wrap around a waist of a user, including one or more attachment loops for connecting accessories;
a collar allowing holstering of a gripper within open space, the collar including at least three sides around the open space;
a height adjuster connected to the collar to adjust a vertical position of the collar; and
a hook to connect the height adjuster to the attachment loops;
wherein the gripper includes:
a trigger; and
retractable fingers to be retracted by the trigger, the retractable fingers fully opening when the trigger is released; and
wherein, when the user holsters the gripper within the open space, the sides of the collar hold the retractable fingers of the gripper in place.

10. The adjustable holster system of claim 9, wherein the collar includes one or more height adjustment tracks.

11. The adjustable holster system of claim 10, wherein the height adjustment track is movable upward and downward in a vertical direction with respect to the belt.

12. The adjustable holster system of claim 9, wherein the open space is fully enclosed.

13. The adjustable holster system of claim 9, wherein the collar tightly secures the gripper when the gripper is holstered and retractable fingers are partially closed.

14. The adjustable holster system of claim 9, wherein the height adjuster includes upper and lower height limits.

15. The adjustable holster system of claim 9, wherein the height adjuster extends in a vertical direction from the hook.

16. The adjustable holster system of claim 9, wherein the hook and the collar are separable.

17. A method comprising:
activating a trigger of a gripper to fully close a set of retractable fingers;
removing the gripper from a collar shaped to allow holstering of the gripper and to allow securing of the retractable fingers against the collar;
holding the gripper to perform an action by a user;
activating the trigger of the gripper to fully close the set of retractable fingers;
holstering the gripper into the collar; and
deactivating the trigger of the gripper to open the set of retractable fingers until contact is made with the collar, securing the retractable fingers against the collar.

18. The method of claim 17, further comprising repeating the steps of activating the trigger to repeatedly holster the gripper into and out of the collar at multiple intervals during the performance of multiple actions.

19. The method of claim 17, further comprising attaching a hook to an attachment loop of a belt.

20. The method of claim 17, further comprising adjusting the height of the collar by operating a height adjuster to adjust a vertical position of the collar.
